(19) United States
(12) Patent Application Publication
(10) Pub. No.: US 2012/0278796 A1
(43) Pub. Date: Nov. 1, 2012

(54) AUTOMATICALLY INSTALLING DEVICE DRIVERS

(75) Inventors: Neil Sandlin, Redmond, WA (US); Chibong Chan, Kirkland, WA (US); Amy Rambhia, Bellevue, WA (US); Mitsuru Saito, Redmond, WA (US)

(73) Assignee: Microsoft Corporation, Redmond, WA (US)

(21) Appl. No.: 13/094,070

(22) Filed: Apr. 26, 2011

(51) Int. Cl. G06F 9/445

(52) U.S. Cl. 717/174

(57) ABSTRACT

When a device is connected to a computer, many computers are configured to seek a driver for a device (e.g., accessible over a network), install either the driver for the device (if accessible) or a default driver, and terminate the installation process. However, this process may delay access to the device until the driver is fully installed, and may leave a device in an incomplete state through the default driver, even if a driver is subsequently accessible. Instead, when a device is connected, the computer may promptly install a default driver in order to provide rapid access to the device. The computer may then begin and persist in seeking access to a driver library containing a driver for the device, and upon (eventually) retrieving the driver, may replace the default driver with the driver, thereby achieving full functionality of the device through the proper driver without involving the user.

### BACKGROUND

Within the field of computing, many scenarios involve the installation on a computer of a device that is controlled by a driver, such as a software interface configured to provide access to the device. For example, the driver may be configured to initiate the device upon installation; to provide a description of the device to other processes; to receive data from the device and provide it upon request to other processes; to send commands to the device; to configure the device to interact with another device; and to configure the device for safe removal or uninstallation. Additionally, various applications may interact with the device; e.g., many types of applications may format output of a document for rendering on a printer.

Many operating environments may be configured to interact with many types of devices, and to receive and invoke many types of drivers therefore. As a first example, the operating environment may, upon detecting a new device, query the user to specify the location of a driver. As a second example, the operating environment may download a driver from the internet, such as from a driver library. As a third example, the operating environment may receive a driver provided by the device (e.g., as part of a “plug and play” environment). As a fourth example, the operating environment may store a default driver set comprising a set of default drivers for various devices, and upon receiving a description of the device, may install a default driver that is suitable for basic and/or standardized operation of the device (e.g., upon detecting a printer, the operating environment may select a default printer driver that is capable of rendering text on many printers, but may be incapable of printing high-resolution documents or images until a driver that is specific to the printer is located and installed). In such ways, the operating environment may select a suitable driver for the device.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While the installation of a driver for a device may be performed in many ways, various configurations of the operating environment in choosing a driver may provide different advantages. For example, some contemporary operating environments may, upon first detecting a connection of a device, endeavor to find a driver for a device (e.g., by examining the local filesystem, querying the manufacturer or a driver library, and/or querying the user to specify the location of a driver). If a suitable driver is not identified during this initial connection, the operating environment may seek to identify a default driver for the device that may provide basic interactivity, or may simply fail to install a suitable driver and may present an error message to the user. However, operating environment may conclude this installation process and may not initiate further attempts to identify a more suitable driver for the device, such as a more specific driver that provides access to enhanced features of the device and/or an updated version of the driver provided by the manufacturer. While the user may seek a new driver and initiate a request for a replacement of the current driver with the new driver, the operating environment may provide little or no automated support for identifying and installing a new or updated driver.

Presented herein are techniques for installing a driver for a device that may improve the automatic initiation, performance, and/or completion of this process. According to these techniques, the operating environment may initially select and install a default driver that may provide rapid access to the device. The operating environment may then seek an accessible driver library that may comprise a specific driver for the device. If the driver library is accessible, the operating environment may promptly replace the default driver with the specific driver. However, if the driver library is not accessible, the operating environment may continue to query for the driver library (e.g., periodically, or upon detecting a connection to a network, an operating environment reboot, or an idle moment within the operating environment). Upon eventually achieving accessibility to the driver library, the operating environment may then retrieve a specific driver for the device, and may replace the default driver with the specific driver. Moreover, after installing the specific driver, the operating environment may continue to seek updated drivers for the device, and may successively replace a current driver with an updated driver. In this manner, the operating environment may automatically initiate the retrieval and updating of drivers for the device while economizing the attention of the user.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring an installation of a driver for a device.

FIG. 2 is an illustration of an exemplary scenario featuring an installation of a driver for a device in accordance with the techniques presented herein.

FIG. 3 is a flow chart illustrating an exemplary method of retrieving and installing a driver for a device.

FIG. 4 is an illustration of an exemplary computer-readable medium comprising processor-executable instructions configured to embody one or more of the provisions set forth herein.

FIG. 5 is a flow chart illustrating another exemplary method of retrieving and installing a driver for a device.

FIG. 6 is an illustration of an exemplary scenario featuring a selection of a default driver for a device from a default driver set.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve a device (e.g., a keyboard, mouse, display device, microphone, speakers, display adapter, sound adapter, storage device, network adapter, or printer) attached to a computer through various types of wired and/or wireless connections. In order to provide access to the capabilities of the device, a piece of software known as a driver is often installed on the computer as an interface with which applications and the operating environment may interact to operate the device. For example, the software may accept input to the device (e.g., the invocation of capabilities or the transmission of data) requested by an application or the operating environment and may relay that data to the device; may accept output from the device (e.g., status reports, user input received from a user input device, or video captured by a camera) to be exposed or provided to various applications and the operating environment; may configure the device to interoperate with other devices; and may mediate the installation of the device in the operating environment and/or the uninstallation of the device from the operating environment.

The driver may be installed on the computer system in various ways. As a first example, a user may provide a driver while installing a device, e.g., by providing removable media packaged with the device that contains an installation package for the driver. As a second example, the operating environment may request a driver for the device from a driver library that is accessible over a network such as the internet or a local area network (LAN), may receive the driver over the network, and may install the driver within the operating environment. As a third example, the operating environment may receive the driver directly from the device, which may store its driver and may be capable of providing the driver to the operating environment during installation while no such driver is currently installed (e.g., a “plug and play” protocol). As a fourth example, the operating environment may have been pre-loaded with a driver for the device. As a fifth option, the operating environment may include a default driver set, comprising default drivers for general classes of device, and the operating environment may select a default driver for the general class of devices that includes the device and that, while unable to interface specifically with the device and provide access to the entire range of capabilities that the specific driver for the device may access, may provide access to basic capabilities that are shared among the devices of the device class. As a first such example, a mouse may include many device-specific features through a specific driver for the device, such as adjusting the sensitivity and customizing the functionality of input buttons, but may also interface with a basic mouse driver in order to deliver user input comprising mouse movement signals and button presses. As a second such example, a display adapter may include many specialized features that may be accessed through the specific driver for the device, such as video acceleration, color correction, and three-dimensional acceleration, but may also be accessible through a default video driver in order to receive a command to set the video mode to particular dimensions and to receive standard video output from the computer.

In view of the range of available drivers for a device (including a default driver), an operating environment may be configured to manage the installation of a driver for the device in many ways. As a first example, when a device is first connected to the computer, the operating environment may perform a sequence of searches and choices in order to identify a driver to be installed, including selecting a driver from a set of suitable drivers. As a second example, the operating environment may apply various types of security restrictions to the driver (e.g., in order to reduce the vulnerability of the operating environment to the installation of malicious software that is provided as a driver by a device that is connected to the computer). As a third example, the operating environment may or may not be configured to check for updates to the driver after installation, and/or to replace a current driver with an updated driver. As a fourth example, when the device is disconnected from the computer, the operating environment may choose to allow the driver to continue running, may place the driver in a suspended state until the device is reconnected, or may remove the driver. Many such choices and processes may be initiated by the computing environment in order to manage the driver for the device.

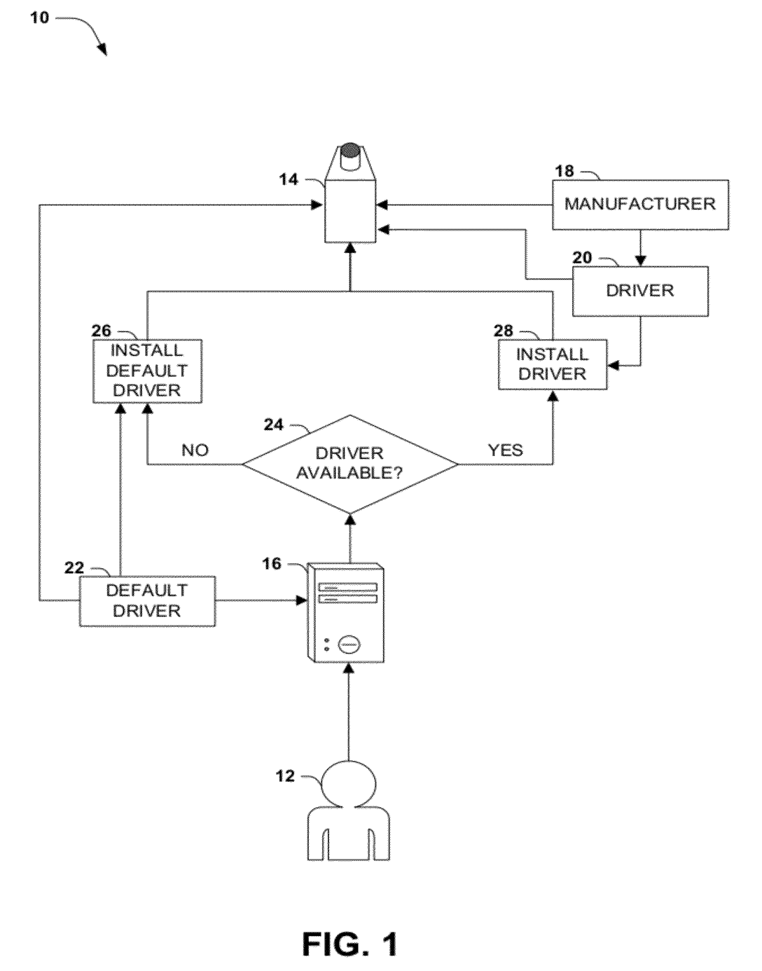

FIG. 1 presents an illustration of an exemplary scenario 10 featuring a user 12 who connects a device 14 (e.g., a video camera) to a computer 16, and the processes that the operating environment for the computer 16 may perform to identify and install a driver for the device 14. When the device 14 is connected to the computer 16, the computer 16 (including the operating environment) may perform a determination 24 of whether a driver 20 is available for the device 14. This determination 24 may involve, e.g., attempting to connect to a driver library; attempting to contact a manufacturer 18 of the device 14 that may provide a driver 20; or scanning the local filesystem to determine whether a driver 20 is locally stored. If the determination 24 is made that the driver 20 is available, the operating environment for the computer 16 installs 28 the driver 20. However, if a determination 24 is made that a driver 20 is not available, then the computer 16 installs 26 a default driver 22 for the device 20 that may provide access to basic capabilities. Upon installing either the driver 20 or the default driver 22, the operating environment of the computer 16 completes the installation of the device 14.

While the exemplary scenario 10 illustrated in FIG. 1 presents some advantages, some disadvantages are also presented. As a first example, in the event of a problem installing the driver 20, the operating environment of the computer 16 installs a default driver 22, but does not subsequently attempt to access the driver 20 in order to replace the default driver 22. For example, the determination 24 of the availability of the device 24 may result in a negative response for many reasons (e.g., a lack of network connection; a network connection having inadequate bandwidth to download a large driver 20; a problem with a website or web service containing the driver 20, such as a driver library or the website of the manufacturer 18; or simply a cancellation of the installation process by the user 12 and/or a removal of the device 14 during installation). While these problems may interfere with the initial installation of the driver 20, these problems may be ephemeral (e.g., network access may be restored or upgraded; the website or web service containing the driver 20 may come back online; or the user 12 may reconnect the device 14 and permit the installation process to complete), and it may later be possible to access the driver 20, but the computer 16 is not configured to do so. Therefore, the default driver 22 remains in place, providing basic but incomplete access to the device 14, until the user 12 manually retrieves the driver 20 and requests the computer 16 specifically to install the driver 20 for the device 14.

A second exemplary problem that may be appreciated with respect to the exemplary scenario 10 of FIG. 1 involves the delay involved in the process. The determination 24 of whether or not a driver 20 is available may take a while (e.g., attempting to communicate with the device 14 to retrieve identifying information, scan the local file system, query one or more online services for the driver 20, and download a potentially large driver 20 over a potentially limited-bandwidth connection), as may installing 28 the driver 20 on the computer 16 and initiating communication with the device 14 through the driver 20. In this time frame, the device 14 is unavailable due to the lack of a driver 20. This unavailability may have been alleviated simply by installing the default driver 22 promptly upon detecting the connection of the device 14, since the default driver 22 is locally available, comparatively simple (e.g., providing comparatively basic capabilities), and may already be pre-loaded in the operating environment of the computer 16 (e.g., as a contingency service, or in order to service other devices 14 of the same type that have been connected to the computer 16). However, the determination 24 and installation of a driver 20 may have proceeded while the basic capabilities of the device 14 were accessible through the default driver 22.

A third exemplary problem that may be appreciated with respect to the exemplary scenario 10 of FIG. 1 involves scenarios wherein the installation of the driver 20 depends upon a default driver 22 first being installed. For example, when a computer 16 is first connected to a display adapter, the computer 16 may not have a current, full-featured driver 20 for the display adapter. The computer may seek to retrieve and configure a full-featured driver 20 for the display adapter, but may have to interact visually with a user in order to achieve this configuration (e.g., presenting a user interface for the user to specify the manufacturer and model of the display adapter, and presenting user controls to allow the user to specify a desired display resolution and rendering features, such as font anti-aliasing). However, because the display adapter does not have a driver 20, the computer may be unable to interact visually with the user. Therefore, a default driver 22 for the display adapter may be installed that provides basic display capabilities, and the computer 16 may interact with the user while retrieving and configuring the full driver 20 for the display adapter. However, this scenario is incompatible with the process illustrated in the exemplary scenario 10 of FIG. 1, wherein the installation of the default driver 22 ends the installation process. Similar problems may arise when installing a driver 20 for an input device; e.g., the installation process for the driver 20 may involve interaction with the user 12 (e.g., “click OK to install the driver”), but the user 12 may be unable to provide the requested input if the input device is not operational due to the absence of a default driver 22. Additional problems may also be apparent from the exemplary scenario 10 of FIG. 1 (e.g., the lack of a driver update function as part of the installation process).

Presented herein are techniques for installing a driver 20 for a device 14 on a computer 16 that may address some or several of the disadvantages apparent in the exemplary scenario 10 of FIG. 1. In accordance with these techniques, the process of installing a driver 20 for a device 14 may be improved by first installing a default driver 22, which may provide prompt access to the basic capabilities of the device 14. The computer 16 may then search for a driver 20, e.g., as part of a driver library that may be available via a network, such as the website of the manufacturer 18, a web service operating in conjunction with the operating environment, or a customized driver database provided by an administrator and accessible over a local area network (LAN). If the computer 16 is initially capable of accessing the driver library, the computer 16 may retrieve the driver 20 and replace the default driver 22 with the driver 20 in order to provide access to the full capabilities of the device 14. However, if the computer 16 is not initially capable of accessing the driver library, the computer 16 may continue checking for access thereto (e.g., periodically, or each time that the device 14 is connected, or upon detecting a reconnection of network service). When the computer 16 is eventually able to contact the driver library, the computer 16 may download the driver 20 and replace the default driver 22 with the driver 20. In this manner, the computer 16 may automatically replace the default driver 22 with the specific driver 20 for the device 14 instead of leaving the device 14 in an incomplete state.

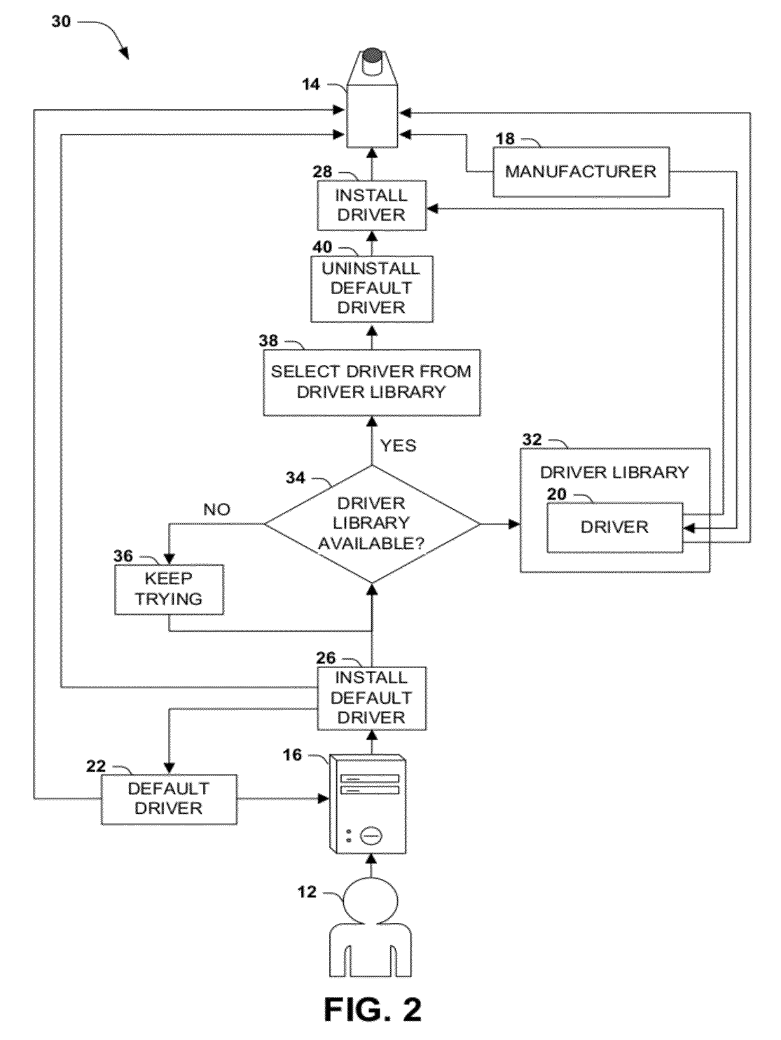

FIG. 2 presents an illustration of an exemplary scenario 30 for installing a driver 20 for a device 14 in accordance with the techniques presented herein. In this exemplary scenario 30, when a user 12 connects a device 14 to a computer 16, the computer 16 (including the operating environment therein) may endeavor to install a driver 20 for the device 14. However, the computer 16 comprises a default driver 22 for the device 14, and first installs 26 the default driver 22 in order to provide rapid access to the basic capabilities of the device 14. The computer 16 then makes a determination 34 of whether a driver library 32 is available. The driver library 32 may comprise, e.g., a web service associated with the operating environment of the computer 16 and where the manufacturer 18 of the device 14 may have deposited a driver 20 for the device 14; a website of a manufacturer 18 of the device 14; or a cache of drivers 20 created and maintained by an enterprise administrator that may be accessible over a local area network (LAN). If this determination 34 is positive, the computer 16 selects 38 the driver 20 from the driver library 32, uninstalls 40 the default driver 22, and installs 28 the driver 20 for the device 14. However, if the determination 34 is negative, the computer 16 simply keeps trying 36 to access the driver library 32 (e.g., periodically, upon detecting each connection of the device 14, or upon detecting a restoration of network service) and again performs the determination 34 of the accessibility of the driver 20. This cyclic process may continue, e.g., until the driver 20 is retrieved and installed on the computer 16. In this manner, the computer 16 achieves rapid access to the device 14 through the default driver 22, and also automatically retrieves and replaces the default driver 22 with the specific driver 20 for the device 14 while conserving the involvement of the user 12. Moreover, although not so illustrated, the process presented in the exemplary scenario 30 of FIG. 2 may be easily extended to provide ongoing updates of the driver 20 for the device 14 in the event of subsequent availability of new versions of the driver 20; e.g., upon installing 28 the driver 20, the computer 16 may simply loop back to a periodic determination 34 of whether the driver library 32 is available, may later attempt to retrieve an updated driver 20, and may replace the first installed driver 20 with the updated driver 20.

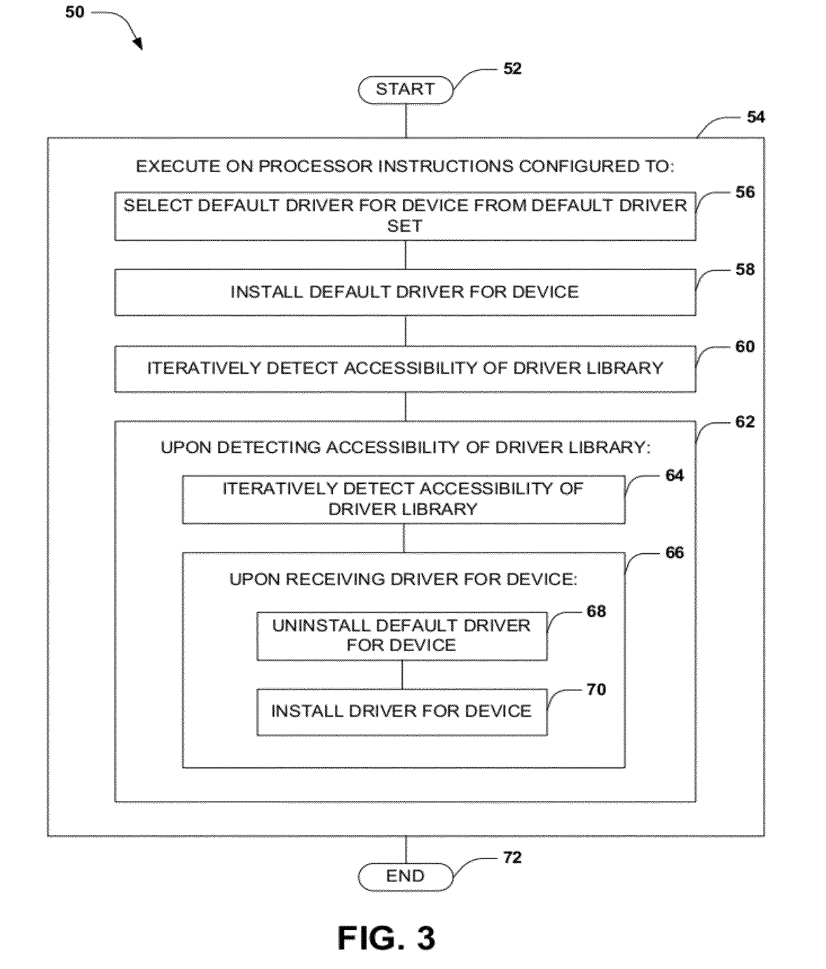

FIG. 3 presents a first embodiment of these techniques, illustrated as an exemplary method 50 of installing a driver 20 for a device 14 having at least one capability on a computer 16 comprising a processor and a default driver set. The instructions may be implemented, e.g., as instructions stored in a memory component of the computer 16 (e.g., a memory circuit, a platter of a hard disk drive, a solid-state storage component, or a magnetic or optical disc) that, when executed on the processor, cause the computer 16 to perform the techniques presented herein. The exemplary method 50 begins at 52 and involves executing 54 the instructions on the processor. Specifically, the instructions are configured to select 56 a default driver 22 for the device 14 from the default driver set, and to install 68 the default driver 22 for the device 14. The instructions are also configured to iteratively detect 60 an accessibility of a driver library 32. The instructions are also configured to, upon detecting 62 the accessibility of the driver library 32, request 64 a driver 20 for the device 14 from the driver library 32, and upon receiving 66 the driver 20 for the device 14, uninstall 68 the default driver 22 for the device 14 and install 70 the driver 20 for the device 14. In this manner, the exemplary method 50 achieves the installation of the driver 20 for the device 14 in accordance with the techniques presented herein, and so ends at 72.

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

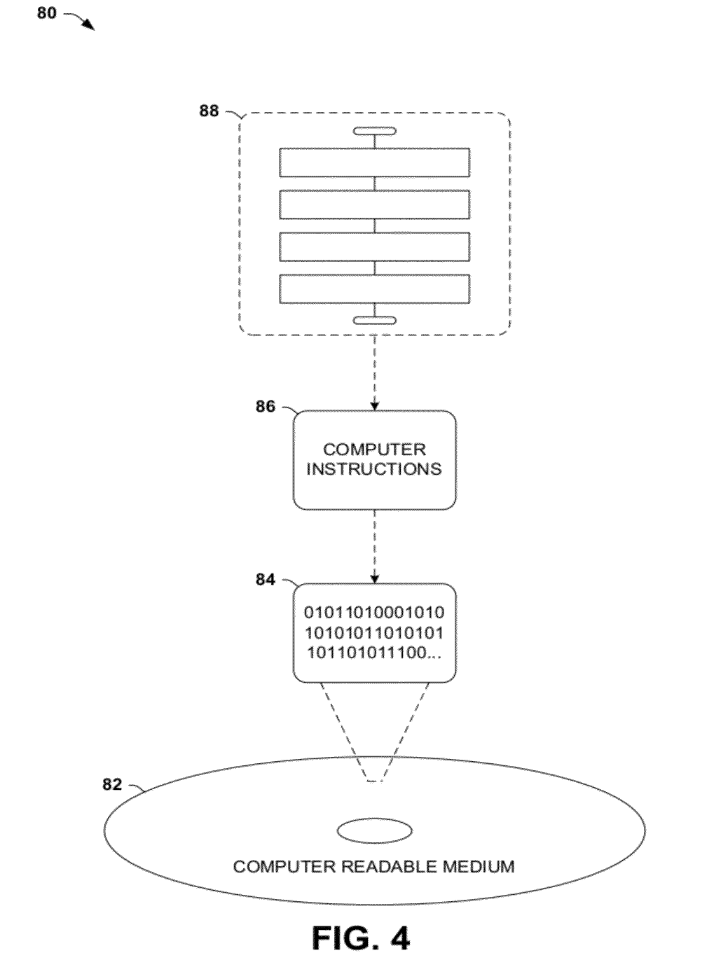

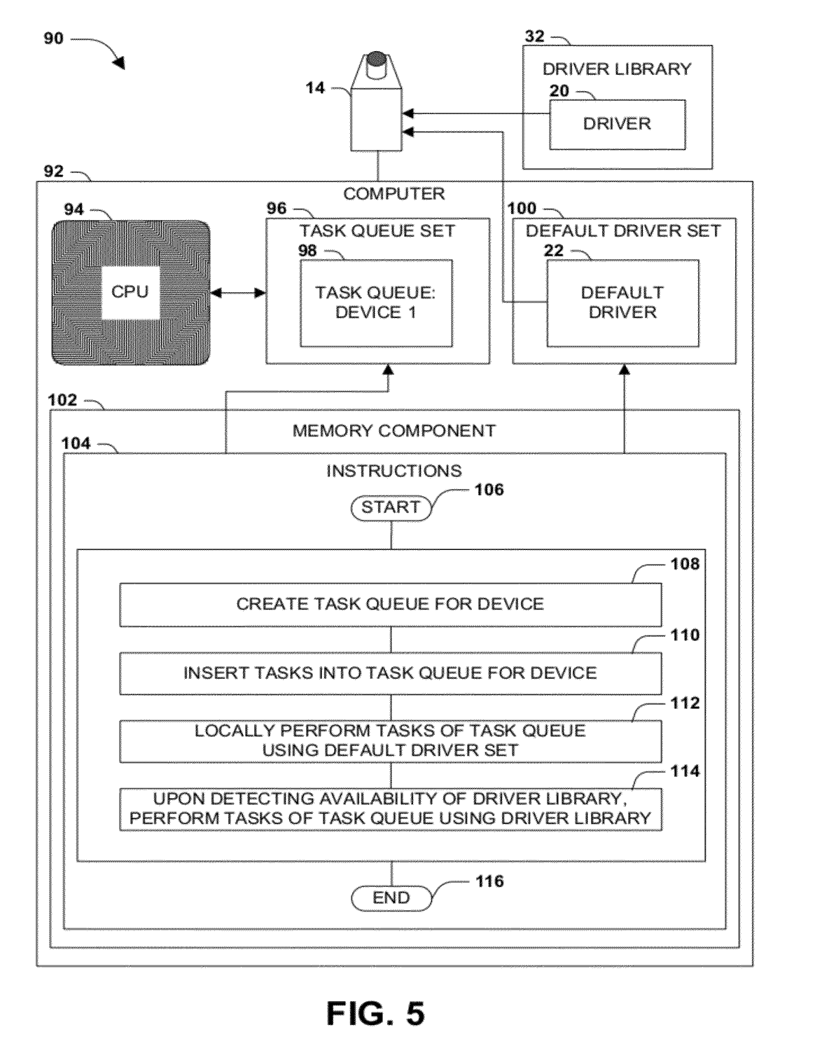

An exemplary computer-readable medium that may be devised in these ways is illustrated in FIG. 4, wherein the implementation 80 comprises a computer-readable medium 82 (e.g., a CD-R, DVD-R, or a platter of a hard disk drive), on which is encoded computer-readable data 84. This computer-readable data 84 in turn comprises a set of computer instructions 86 configured to operate according to the principles set forth herein. In one such embodiment, the processor-executable instructions 86 may be configured to perform a method of retrieving and installing a driver for a device, such as the exemplary method 50 of FIG. 3 or the exemplary method 94 of FIG. 5. Some embodiments of this computer-readable medium may comprise a nontransitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 50 of FIG. 3 and the exemplary method 94 of FIG. 5) to confer individual and/or synergistic advantages upon such embodiments.

A first aspect that may vary among embodiments of these techniques involves the scenarios wherein such techniques may be implemented. As a first example of this first aspect, these techniques may be utilized to install drivers 20 for many types of devices 14, such as display adapters; network adapters; input devices such as mice, keyboards, cameras, and microphones; output devices such as speakers and printers; and storage devices such as hard disk drives, solid-state storage components, magnetic or optical disc drives, and tape drives. Moreover, these components may be connected to the computer 16 through various wired protocols (e.g., Ethernet, universal serial bus (USB), IEEE 1394, serial ATA, or RS-232 and/or wireless protocols (e.g., 802.11, infrared, or optical wireless protocols). As a second example of this first aspect, many types of driver libraries 32 may be involved in these techniques, such as a web service provided by the manufacturer 18 of the device 14 and/or the computer 16 (including the operating environment of the computer 16), or an enterprise administrator who may compile a set of drivers 20 for various devices 14 in use throughout the enterprise and may provide access to such drivers 20 over a network.

As a third example of this first aspect, these techniques may be implemented as many types of processes on a computer 16, including a portion of the operating environment, such as a daemon or background process that loads upon starting the computer 16 and remains available to install drivers 20 for devices 14, or as an application that may be invoked by the operating environment or the user 12 in order to manage the installation of drivers 20 for devices 14. Additionally, the architecture of such processes may take many forms. As a first such example, the techniques may be performed by a process that simply performs the elements of the exemplary method 50 of FIG. 3, and simply follows the logic expressed therein through to completion. Alternatively, the techniques may be devised as a task-based architecture, comprising a set of tasks loaded into a task queue for the device 14 that together implement the techniques presented herein. The device 14 and/or a software process servicing the device 14 may iterate through the tasks of the task queue and, by performing each task of the task queue, install the driver 20 according to the techniques presented herein.

FIG. 5 presents an illustration of an exemplary scenario 90 featuring a task-based architecture of the techniques presented herein. In this exemplary scenario 90, a device 14 is connected to a computer 92 comprising a processor 94, a task queue set 96 comprising one or more task queues 98 for respective devices 14 or other components of the operating environment of the computer 92, and a default driver set 100 comprising at least one default driver 22. The computer 92 may or may not be in communication with a driver library 32 comprising a driver 20 for the device 14. The computer 92 may also comprise a memory component 102 comprising a set of instructions (e.g., a memory circuit, a platter of a hard disk drive, a solid-state storage component, or a magnetic or optical disc) that, when executed on the processor, comprise an exemplary method that causes the computer 16 to perform the techniques presented herein. In particular, the instructions 104 begin at 106 and involve creating 108 a task queue 98 for the device 14 in the task queue set 96. The instructions 104 also involve inserting 110 tasks into the task queue 98 for the device 14 that perform various portions of the techniques presented herein (e.g., corresponding to respective elements of the exemplary method 50 of FIG. 3). For example, the tasks may include a device identifying task that is configured to identify the device 14 (e.g., retrieving metadata describing the device 14, such as the manufacturer 18, the model number, and the capabilities of the device 14); a device driver installing task that is configured to install a device driver 20 for the device 14; a device metadata package installing task that is configured to install a metadata package for the device 14; a device application installing task configured to install an application for the device 14; and a device installation completing task that is configured to complete the installation of the device 14. The instructions 104 also involve locally performing 112 the tasks of the task queue 98 of the device 14 using the default driver set 100 (e.g., upon detecting a connection of the device, the instructions 104 may first initiate the performance of the tasks of the task queue 98 in order to achieve the installation of the default driver 22). However, the instructions 104 are also configured to, upon detecting an availability of the driver library 32, perform the tasks of the task queue 98 using the driver library 32 in order to achieve the installation of the driver 20 for the device 14. In this manner, the task-queue-based architecture implemented by the instructions 104 of FIG. 5 may achieve the installation of the driver 20 for the device 14 according to the techniques presented herein.

A task-based architecture of the type illustrated in FIG. 5 may present some advantages with respect to other architectures. As a first example, an implementation in the form of a set of tasks comprising a task queue 98 may enable another system component of the computer 16, such as a task scheduler, to manage the installation of the driver 20 for the device 14, rather than implementing a separate process to handle this installation. As a second example, the performance of the tasks of the task queue 98 may be adjusted in various ways. For example, the task queue 98 may first be performed through to completion using the default driver set 100 in order to install the default driver 22. However, upon detecting the availability of the driver library 32, the computer 16 may restart the task queue 98 to begin the tasks anew using the driver library 32 and the driver 20 contained therein. Alternatively, the task queue 98 may first be performed as far as possible using the default driver set 100 and the default driver 22; e.g., as many tasks as may be successfully completed may be locally performed on the computer 16, and may be removed from the task queue 98. However, upon detecting a failure in the task queue 98 when performed with the default driver set 100, the computer 16 may suspend the performing of the tasks using the default driver set 100 with at least one remaining task in the task queue 98; and upon detecting the availability of the driver library 32, the computer 16 may resume the task queue 98, and may perform the remaining tasks in the task queue 98. In this manner, the tasks of the local installation of the device 14 using the default driver set 100 and the default driver 22 that are not altered by the installation using the driver library 32 and the driver 20 may remain in effect, and only the tasks of the installation that are different between the default driver 22 and the driver 20 are performed upon connecting to the driver library 32. Those of ordinary skill in the art may devise many scenarios wherein the techniques presented herein may be utilized.

A second aspect that may vary among embodiments of these techniques relates to the contents of a driver 20 (including a default driver 22) for a particular device 14. As a first example, the driver 20 may include various libraries comprising sets of functions that may be invoked to send particular commands or provide data to the device 14, and/or to configure the operating environment of the computer 16 to receive data from the device 14 (e.g., an allocation of a memory buffer to store data streamed from the device 14, and/or the installation of a process to receive and store such data). As a second example, the driver 20 for a device 14 may include a metadata package that describes the device 14, such as product information (e.g., a picture of the device 14, a purchase, activation, license, or warranty date relating to the device 14, or a model number, product number, or serial number identifying the device), a list of capabilities of the device 14, a list of functions that may be invoked by a user or an application with respect to the device 14, or product documentation. This metadata package may be included with the driver 20 (or may be associated with the driver 20), and in one such embodiment, this metadata package may be received and installed with the driver 20 for the device 14.

As a third example of this second aspect, the driver 20 for a device 14 (including a default driver 22 for all devices 14 within a general device class) may include one or more applications that interface with the device 14. For example, a device 14 comprising a camera may include one or more applications for playing, editing, performing format conversion, or creating a library of captured audio and video clips, as well as applications for managing the device 14, such as an interface to the memory of the camera. These applications may be included with the driver 20 (or may be associated with the driver 20), and may be received with the driver 20. This installation may be prefaced on the consent of the user 12; e.g., the computer 16 may present to the user 12 an offer to install the application, and may install the application upon receiving from the user 12 an acceptance of the offer. Additionally, the computer 16 may be configured to invoke the application interfacing with the device 14 after installation (e.g., an “autoplay” feature that invokes a user interface for the device 14 upon connecting and/or installing the device 14). This invocation may also be prefaced on the consent of the user 12; e.g., after installing an application as part of a driver 20, the computer 16 may present to the user 12 an offer to invoke the application, and may do so upon receiving an acceptance of the offer from the user 12. Those of ordinary skill in the art may choose many types of additional components that may be included with a driver 20 (including a default driver 22) to be installed and/or utilized according to the techniques presented herein.

A third aspect that may vary among embodiments of these techniques relates to the manner of selecting a default driver 22 for the device 14 from the default driver set 100. As a first example, the default driver set 100 may include default drivers 22 that each support devices 14 having a particular set of capabilities, such as a data storage capability, a data streaming capability, an image capturing capability, a video capturing capability, and a video displaying capability. In order to select a default driver 22 for a device 14, an embodiment of these techniques may identify at least one capability of the device 14, and may select a default driver 22 from the default driver set 100 that supports at least one capability of the device 14. In some scenarios, more than one default driver 22 may be installed to support one or more capabilities of the device 14.

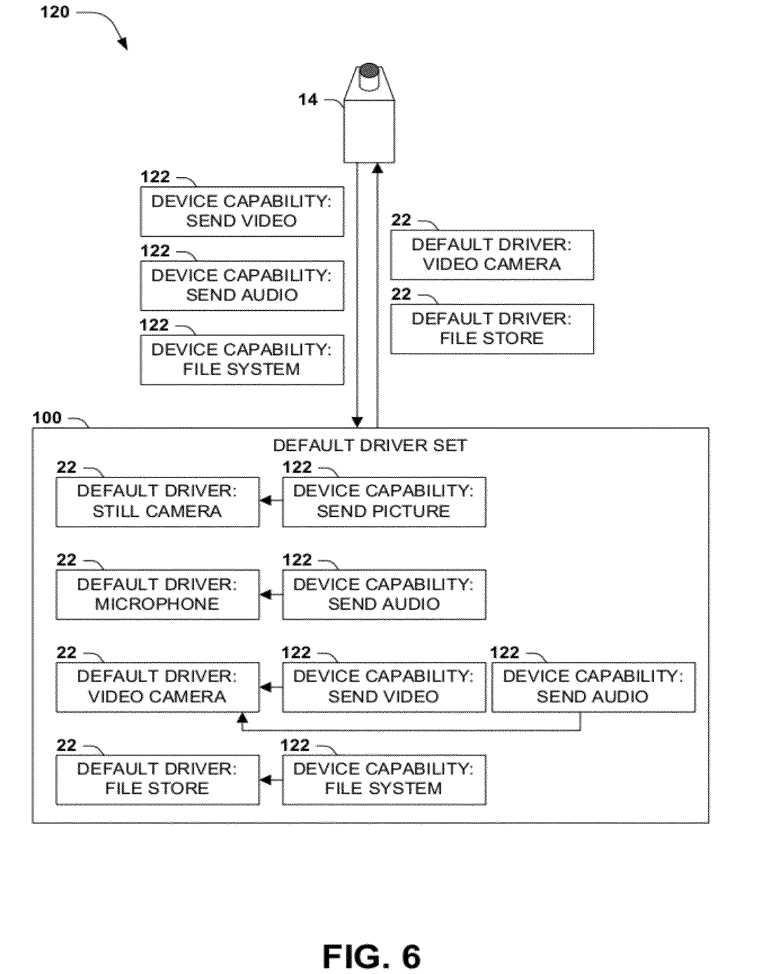

FIG. 6 presents an illustration of an exemplary scenario 120 featuring the selection of a default driver 22 for a device 14 based on the detected capabilities 122 thereof. In this exemplary scenario 120, a device 14 comprising a videocamera is connected to a computer 16 that, in accordance with the techniques presented herein, endeavors to select appropriate default drivers 22 in order to provide access to the basic functionality of the device 14. To this end, an embodiment of these techniques may identify one or more capabilities 122 of the device 14, such as a video sending capability, an audio sending capability, and a file system capability. The embodiment may then search the default driver set 100 for default drivers 22 that, together, cover many or all of the capabilities 122 of the device 14. In this exemplary scenario 120, the embodiment may select a video camera default driver 22, which supports the capabilities 122 of sending video and sending audio, and also a file store default driver 22, which supports the capability 122 of interfacing with a device 14 having a file store. In this manner, the set of default drivers 22 selected and installed by an embodiment of these techniques may provide access to the basic capabilities of the device 14.

As a second example of this third aspect, in some scenarios, the installation of a default driver 22 for the device 14 may fail (e.g., the capabilities 122 of the device 14 may be unusual and/or new, and a default driver 22 may not be found that supports such capabilities 122), and an embodiment of these techniques may notify the user 12 of the failure to install a default driver 22 for the device 14. Those of ordinary skill in the art may devise many variations in the installation of the default driver 22 for the device 14 in accordance with the techniques presented herein.

A fourth aspect that may vary among embodiments of these techniques relates to the manner of installing the driver 20 from the driver library 32. As a first example, the detection of the availability of the driver library 32 may be performed in many iterative ways, such as upon detecting an availability event (e.g., an event indicating a change in the computer 18 that may suggest the availability of the driver library 32). An exemplary availability event set may comprise a periodic event (e.g., an elapsing of a period of time that prompts a new attempt to access the driver library 32); a computer restart event (e.g., a rebooting of the computer 16 and/or restarting of the operating environment); a device detection event (e.g., a reconnection of the device 14 to the computer 16); a device access event (e.g., an attempt by the user 12 or a process to access the device 14); a device request event (e.g., a request initiated by the device 14 to contact the driver library 32 to obtain the driver 20); a network availability event (e.g., a detected restoration of network availability or expansion of network capacity); and a user request event (e.g., a request received from the user 12 to access the driver library 32).

As a second example of this fourth aspect, an embodiment of these techniques may be configured to, upon receiving a driver 20 from the driver library 32 for the device 14, await a safe driver update point before updating the driver 20. Because the installation of the driver 20 involves the removal of the default driver 22 for the device 14, this removal may cause problems with the device 14 in some scenarios (e.g., when the user 12 or a process is accessing the device 14). Therefore, it may be advantageous for the embodiment to wait until reaching a safe driver update point (e.g., a moment when the device 14 is not in use, and when the removal of the default driver 22 may not cause problems) before implementing the replacement. As one such example, the embodiment may simply ask the user 12 to identify a safe driver update point (e.g., an offer to install the driver 20), and may proceed with the removal of the default driver 22 and the installation of the driver 20 for the device 14 upon receiving an acknowledgment from the user 12. Those of ordinary skill in the art may devise many ways of installing the driver 20 for the device 14 in accordance with the techniques presented herein.

A fifth aspect that may vary among embodiments of these techniques relates to additional features that may be included in various embodiments. As a first such example, before installing the default driver 22, an embodiment of these techniques may first query the computer 16 to identify a driver 20 for the device 14 that may already be installed; and upon identifying such a driver 20 stored on the computer 18, may install the driver 20 for the device 14 instead of the default driver 22. For example, the device 14 may have previously been connected and disconnected, thereby leaving behind a driver 20 for the device 14 that may be installed instead of the default driver 22. As another such example, another instance of the device 14 may already be installed on the computer 16, and the driver 20 installed for the other instance may be suitable for the current instance as well. As a third such example, the operating environment of the computer 16 may be pre-equipped with installed drivers 20 for devices 14 that are frequently installed in computers 16 (e.g., a pre-installed driver for a flash drive), and may simply invoke the already installed driver 20 for the device 22 instead of installing the default driver 22 and retrieving the driver 20 from the driver library 32.

As a second example of this fifth aspect, instead of being received from a driver 20 (including a default driver 22) may be received from the device 14 (e.g., in a computer 16 supporting a “plug-and-play” feature). Alternatively, the driver 20 (including a default driver 22) may be specified by the user 12; e.g., the user 12 may specify a location of the driver 20 and/or default driver 22 within the file system of the computer 16.

As a third example of this fifth aspect, after installing the driver 20 for the device 14, these techniques may continue to be utilized in order to achieve an updating of the driver 20 for the device 14. For example, after installing a first driver for the device 14, an embodiment of these techniques may continue detecting an accessibility of the driver library 32 (e.g., a periodic check for access to the driver library 32), and upon detecting the accessibility of the driver library 32, may request an updated driver for the device 14 from the driver library 32; and upon receiving the updated driver for the device 14, the embodiment may uninstall the first driver for the device 14 and install the updated driver for the device 14. This variation may be achieved, e.g., in the exemplary method 50 of FIG. 3, instead of ending at 72 after installing 70 the driver 20 for the device 14, looping around to iteratively detecting 60 the accessibility of the driver library 32. Alternatively, in the task-queue-based architecture illustrated in the exemplary scenario 90 of FIG. 5, this variation may be achieved by, instead of removing tasks from the task queue 98 upon completion, restarting the task queue 98 after installing the driver 20 for the device 14. In this manner, the same techniques and components that are implemented to achieve the installation of the driver 20 for the device 14 may also achieve the updating of the driver 20 for the device 14 when new versions of the driver 20 are available in the driver library 32. Those of ordinary skill in the art may devise many additional features that may be compatible with the implementation of the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

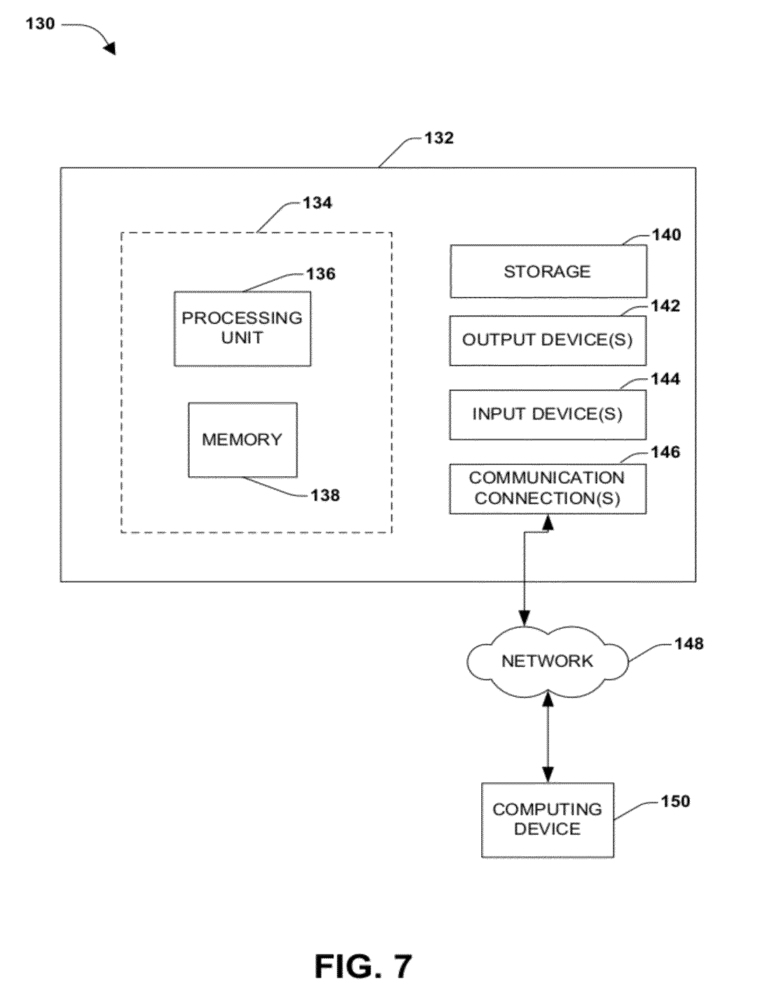

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 130 comprising a computing device 132 configured to implement one or more embodiments provided herein. In one configuration, computing device 132 includes at least one processing unit 136 and memory 138. Depending on the exact configuration and type of computing device, memory 138 may be volatile (such as RAM, for example), non-volatile (such as ROM, flash memory, etc., for example) or some combination of the two. This configuration is illustrated in FIG. 7 by dashed line 134.

In other embodiments, device 132 may include additional features and/or functionality. For example, device 132 may also include additional storage (e.g., removable and/or non-removable) including, but not limited to, magnetic storage, optical storage, and the like. Such additional storage is illustrated in FIG. 7 by storage 140. In one embodiment, computer readable instructions to implement one or more embodiments provided herein may be in storage 140. Storage 140 may also store other computer readable instructions to implement an operating system, an application program, and the like. Computer readable instructions may be loaded in memory 138 for execution by processing unit 136, for example.

The term “computer readable media” as used herein includes computer storage media. Computer storage media includes volatile and nonvolatile, removable and non-removable media implemented in any method or technology for storage of information such as computer readable instructions or other data. Memory 138 and storage 140 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 132. Any such computer storage media may be part of device 132.

Device 132 may also include communication connection(s) 146 that allows device 132 to communicate with other devices. Communication connection(s) 146 may include, but is not limited to, a modem, a Network Interface Card (NIC), an integrated network interface, a radio frequency transmitter/receiver, an infrared port, a USB connection, or other interfaces for connecting computing device 132 to other computing devices. Communication connection(s) 146 may include a wired connection or a wireless connection. Communication connection(s) 146 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 132 may include input device(s) 144 such as keyboard, mouse, pen, voice input device, touch input device, infrared cameras, video input devices, and/or any other input device. Output device(s) 142 such as one or more displays, speakers, printers, and/or any other output device may also be included in device 132. Input device(s) 144 and output device(s) 142 may be connected to device 132 via a wired connection, wireless connection, or any combination thereof. In one embodiment, an input device or an output device from another computing device may be used as input device(s) 144 or output device(s) 142 for computing device 132.

Components of computing device 132 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 132 may be interconnected by a network. For example, memory 138 may be comprised of multiple physical memory units located in different physical locations interconnected by a network.

Those skilled in the art will realize that storage devices utilized to store computer readable instructions may be distributed across a network. For example, a computing device 150 accessible via network 148 may store computer readable instructions to implement one or more embodiments provided herein. Computing device 132 may access computing device 150 and download a part or all of the computer readable instructions for execution. Alternatively, computing device 132 may download pieces of the computer readable instructions, as needed, or some instructions may be executed at computing device 132 and some at computing device 150.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of installing a driver for a device having at least one capability on a computer comprising a processor and a default driver set, the method comprising:
executing on the processor instructions configured to:
select a default driver for the device from the default driver set;
install the default driver for the device;
iteratively detect an accessibility of a driver library; and
upon detecting accessibility of the driver library:
request a driver for the device from the driver library, and
upon receiving the driver for the device:
uninstall the default driver for the device; and
install the driver for the device.

2. The method of claim 1, installing a driver comprising: installing a metadata package describing the device.

3. The method of claim 1, installing a driver comprising: installing at least one application interfacing with the device.

4. The method of claim 3, installing the at least one application comprising:
presenting to a user an offer to install the application; and
upon receiving from the user an acceptance of the offer, installing the application.

5. The method of claim 3, comprising: upon installing an application, invoking the application interfacing with the device.

6. The method of claim 5, invoking the application comprising:
presenting to a user an offer to invoke the application; and
upon receiving from the user an acceptance of the offer, invoking the application.

7. The method of claim 1:
the computer comprising a default driver set comprising at least one default driver supporting devices having at least one capability; and
installing the default driver comprising: selecting a default driver for the device from the default driver set based on at least one capability of the device.

8. The method of claim 7, selecting a default driver for the device comprising:
detecting at least one capability of the device, and
selecting default driver from the default driver set supporting at least one capability of the device.

9. The method of claim 1, installing the default driver comprising:
querying the computer to identify a driver for the device; and
upon identifying a driver for the device stored on the computer, installing the driver instead of the device driver.

10. The method of claim 1, the instructions configured to, upon detecting a failure to install a default driver for the device, notify a user of the failure.

11. The method of claim 1, iteratively detecting the availability of the driver library comprising: detecting the availability of the driver library upon an availability event selected from an availability event set comprising:
a periodic event;
a computer restart event;
a device detection event;
a device access event;
a device request event;
a network availability event; and
a user request event.

12. The method of claim 1, the instructions configured to, upon receiving the driver for the device, await a safe driver update point.

13. The method of claim 14, awaiting a safe driver update point comprising:
presenting to a user an offer to install the driver; and
upon receiving from the user an acceptance of the offer, installing the driver.

14. The method of claim 1, installing a driver comprising: receiving a driver from the device.

15. The method of claim 1, installing a driver comprising: selecting a driver specified by a user.

16. The method of claim 1, the instructions configured to, after installing a first driver for the device:
iteratively detect an accessibility of a driver library; and
upon detecting accessibility of the driver library:
request an updated driver for the device from the driver library, and
upon receiving the updated driver for the device:
uninstall the first driver for the device; and
install the updated driver for the device.

17. A method of installing a driver for a device having at least one capability on a computer comprising a processor and a default driver set, the method comprising:
executing on the processor instructions configured to:
upon detecting the device:
create a task queue for the device, and
insert tasks into the task queue for the device, the tasks comprising:
a device identifying task configured to identify the device;
a device driver installing task configured to install a device driver for the device;
a device metadata package installing task configured to install a metadata package for the device;
a device application installing task configured to install an application for the device; and
a device installation completing task configured to complete installation of the device;
locally perform the tasks of the task queue using the default driver set; and
upon detect an availability of a driver library, perform the tasks of the task queue using the driver library.

18. The method of claim 17, the instructions configured to, upon detecting the availability of the driver library, restart the task queue for the device.

19. The method of claim 17:
the instructions configured to, upon completing a task, remove the task from the task queue;
locally performing the tasks of the task queue comprising: upon detecting a failure in the task queue performed with the default driver set, suspending the performing of the tasks using the default driver set with at least one remaining task in the task queue; and
performing the tasks of the task queue using the driver library comprising: upon detecting the availability of the driver library, resuming performing the remaining tasks in the task queue.

20. A computer-readable storage medium comprising instructions that, when executed on a processor of a device, install a driver for a device having at least one capability on a computer comprising a processor and a default driver set by:
querying the computer to identify a driver for the device;
upon identifying a driver for the device stored on the computer, installing the driver instead of the device driver;
detecting at least one capability of the device;
selecting a default driver for the device from the default driver set supporting the at least one capability of the device;
installing the default driver for the device;
upon detecting a failure to install a default driver for the device, notifying a user of the failure;
detecting an accessibility of a driver library upon an availability event selected from an availability event set comprising:
a periodic event;
a computer restart event;
a device detection event;
a device access event;
a device request event;
a network availability event; and
a user request event;
upon detecting accessibility of the driver library:
requesting a driver for the device from the driver library; and
upon receiving for the device a driver comprising a metadata package and at least one application interfacing with the device:
awaiting a safe driver update point;
uninstalling the default driver for the device; and
installing the driver for the device;
installing the metadata package describing the device;
installing respective applications interfacing with the device by:
presenting to a user an offer to install the application;
upon receiving from the user an acceptance of the offer, installing the application;
presenting to a user an offer to invoke the application; and
upon receiving from the user an acceptance of the offer, invoking the application; and
after installing a first driver for the device:
iteratively detecting an accessibility of a driver library; and
upon detecting accessibility of the driver library:
requesting an updated driver for the device from the driver library, and
upon receiving the updated driver for the device:
uninstalling the driver for the device; and
installing the updated driver for the device.
